(19) United States
(12) Patent Application Publication
(10) Pub. No.: US 2006/0195563 A1
(43) Pub. Date: Aug. 31, 2006

(54) Peer-to-peer inventory management system

(76) Inventors: Christopher Chapin, San Diego, CA (US); Henry Eisenson, San Diego, CA (US); Eric Eisenson, San Dego, CA (US)

Correspondence Address: CATALYST LAW GROUP, APC, 9710 SCRANTON ROAD, SUITE S-170, SAN DIEGO, CA, 92121, US

(21) Appl. No.: 11/345,842

(22) Filed: Feb. 1, 2006

Related U.S. Application Data
(60) Provisional application No. 60/648,906, filed on Feb. 1, 2005.
(60) Provisional application No. 60/756,757, filed on Jan. 6, 2006.
(60) Provisional application No. 60/652,691, filed on Feb. 14, 2005.

(30) Foreign Application Priority Data
Jan. 27, 2006 (WO) PCT/US06/03166

(51) Int. Cl. G06F 15/173

(52) U.S. Cl. 709/223; 709/224

(57) ABSTRACT

A software tool, message construction and peer-to-peer internet communication methodology by which otherwise independent retailers that sell the same product lines can cost-effectively equalize inventory, facilitating the movement of items from geographic markets in which the items are slow-moving to geographic markets in which the items are faster-moving.

### RELATED APPLICATION

Benefit of priority under 35 U.S.C. 119(e) is claimed herein to U.S. Provisional Application No.: 60/648,906, filed Feb. 1, 2005; U.S. Provisional Application No.: 60/756,757, filed Jan. 6, 2006; PCT Application, Attorney Docket No. 8099-003-WO, Entitled: Inventory Equalization System, filed Jan. 27, 2006. The disclosure of the above referenced application is incorporated by reference in its entirety herein.

### FIELD OF THE INVENTION

The present invention relates generally to the field of product distribution, where imperfect stocking or manufacturing decisions can result in accumulations of excess inventory at some points and deficiencies of inventory at other points. The present invention provides a system by which users can cost-effectively and profitably equalize inventory, facilitating the movement of items from geographic markets and participating nodes in which they are slow-moving to geographic markets and participating nodes in which they are faster moving via a peer-to-peer inventory management system.

### BACKGROUND

There exists a spectrum of methodologies by which inventory is managed by retailers with multiple outlets, distributors, wholesalers, and manufacturers with multiple distribution points, all intended to improve profitability of the overall system optimizing the relationship between the cost of maintaining inventory and the revenue generated by that inventory. The systems and methods of the prior art attempt to manage inventory by forecasting and optimizing movement of inventory from manufacturer to consumer. These inventions are directed towards such things as systems and methods for managing the rate of use of inventory by a supplier and calculating therefrom the proper time for ordering more inventory. Also, systems and methods for managing variable priced inventory, e.g., travel services, using a multi-layered SKU system. And, systems and methods for moving inventory from storage to the sales floor before the storage cost per item causes the retailer's profit to significantly diminish.

U.S. Pat. No. 6,643,626, issued to Perri de Resende and titled Sales Point Business Method and Apparatus, generally describes remotely monitoring a display case having merchandise. The described purpose for remotely monitoring the display case is to assure that authorized users are accessing the merchandise, to monitor transactions involving the merchandise, and/or to provide security against theft, fire and other hazards. This invention allows for the remote monitoring of merchandise to detect the depletion of the merchandise, whether by desired or undesired means. The invention does not provide a means for managing the merchandise inventory amounts.

U.S. Pat. No. 6,405,177, issued to DiMattina and titled System for Securing Commercial Transactions Conducted On-Line, generally describes a system and method allowing on-line retailers to offer guaranteed financial services in addition to their goods. The financial services are such things as secure credit card transactions, price guarantees, guaranteed delivery and return policies and implied warrantee guarantees. The system for accomplishing this method comprises a purchaser-retailer transaction means, a single action (“one click”) component, and a means for sending the financial services certificate to the purchaser. While this patent is related to selling a retailer's inventory, it in no way is capable of managing inventory.

United States Patent Application No.: 2005/0075945, by Matsumoto et al. and titled Inventory Management and Ordering System, and Ordering Management System Using the Previous System, describes a system for managing a businesses inventory. The system monitors the quantity of an item inventory and the rate of use is determined so that future order dates can be predicted. Orders are placed based on the forecast, thereby keeping an adequate supply of an item. While this invention recognizes the need for inventory management, it focuses only on timely ordering of supplies to maintain an item on hand. The dynamics of inventory management being much more complex than striking a balance between use of goods and ordering of goods, this invention is limited to only a small sub-set of inventory management.

United States Patent Application No.: 2003/0036981, by Vaughn et al. and titled System and Method for Managing Inventory, describes a method and system wherein a retailer provides available inventory to a server and a potential consumer can shop the inventory from the server. The invention is that the inventory, which is related to travel, is defined in the travel server by SKU group, record and unit. These different levels of SKU are necessary with travel-based inventory, which is unique inventory. For example, the price of a single travel-based good can vary based on how far in advance the good is purchased. This invention provides a means for accounting for such variance in goods price. The retailer provides information for the SKU levels on available inventory, and the potential consumer searches for specific products based on a query that is addressed and processed at the SKU levels. The server matches the two. This invention manages inventory by providing a specific means to shop for travel based goods.

United States Patent Application No.: 2005/0033666, by Kurashige and titled Inventory Management Method and Program Product, generally describes a management server having an inventory database, a purchase database and a sales database. The server is designed to track certain inventory indicators and uses these indicators to move goods from inventory to sales. By tracking these indicators, inventory that is kept in storage can be moved to sales before the cost of the storage factored into each good diminishes the profits. It is desirable to keep products flowing from storage to the sales floor and in turn out the door. But, this patent does not address the problem of inventory that does not sell or inadequate inventory to meet demand.

United States Patent Application No.: 2005/0004831, by Najmi et al. and titled System Providing for Inventory Optimization in Association with a Centrally Managed Master Repository for Core Reference Data Associated with an Enterprise, describes a system and method for developing an inventory plan for a supply chain. The supply chain is defined as the chain of participants beginning with suppliers including the manufacturers and vendors and ending with the consumer. The inventory plan is an optimized plan that assures that the members of the supply chain are able to predict proper inventory amounts based on a variety of defined metrics. If metrics reach a critical/problematic point, the plan is adjusted to account therefore. New metrics can be added. This invention recognizes and addresses the problems with overstock and understock in a supply chain and attempts to develop a dynamic inventory plan that will prevent the occurrence of these problems. However, given the unpredictable nature of the consumer, this invention cannot address inventory problems that arise from an unexpected change in consumer demand.

U.S. Pat. No. 6,892,210, by Erickson et al., titled Database Management And Synchronization Across A Peer-To-Peer Network, describes a protocol for allowing multiple users to synchronize their records within the defined sharing community dictated by a database. The synchronization is brought about by using “synchronization objects” which contain the information about a change in a specific record or the addition of a new record and such updating happens in the database. There is no communication between users other than the synchronizing or matching the records so that they appear identical on both computers.

At any level (manufacturer, distributor/wholesaler, or retailer), inventory excess is expensive, and there have evolved many business methods for dealing with the problem. The most visible is to discount the price from the planned one, motivating buyers in the chain to move the merchandise. This has the effect of reducing margins and therefore profits, but is a better business method solution than doing nothing, which results in languishing and obsolescing inventory.

Another method for dealing with the problem is to package such obsolescing product, discount it, and ship it to off-price distributors and retailers, which has the same net effect of reducing margins and profits. Both of these steps have another effect that is highly negative and not as visible; branded merchandise appears for sale at a discount, which owners of such brands work hard to prevent. Many brands are protected aggressively. There are often agreements between the distribution system and the manufacturer or importer intended to prevent such discounted sales, or transfers to distribution that is not pre-authorized by the manufacturer or importer.

In such cases, branded merchandise manufacturers often establish a buy-back program to help prevent discounting, by authorized outlets, and to help prevent their merchandise from reaching discount outlets. Such returns come at a high price, however. First, they result in a credit against future orders, which does not help a cash-needy situation. Second, they are credited at a high discount compared to the original shipping invoice (15% or more). Third, retaining the right to sell a particular brand often requires maintenance of a certain volume of sales, and returns negatively impact that volume and can jeopardize retention of that sales right.

Another business method that has emerged to deal with the problem is clandestine shipment by an authorized dealer in branded merchandise to an unauthorized dealer. This is usually a violation of the contract between the authorized dealer and the distributor or manufacturer, and sometimes occurs via nighttime transfers to trucks in alleys, but has the effect of converting excess inventory into ready cash. The risk is to the “franchise” held by the authorized dealer, but in the absence of trackable serial numbers that risk is small, and the result is a loss of brand protection.

Excess inventory is expensive, and its value decreases steadily. That decrease is often more rapid than the rate of sale of the stock, and waning sales often will not even replace the cost of money spent to buy the inventory in the first place. Tax authorities recognize the situation and permit deductions for obsolescing inventory, acknowledging that costly aspect of doing business in a supply-demand system where prediction is imperfect. A cost-effective business method that satisfies the problem would increase profit for every link in the system.

For all these reasons and more, all components of the system including manufacturers, wholesalers/distributors, and retailers seek ways and means to relieve the excess inventory problem.

One potential solution to a deficiency in inventory is to place an order for more. At the retail level, and sometimes at the wholesale/distribution level, this solution is impractical. When the original imperfection in judgment resulted in one or two items selling out earlier than expected, or the unplanned success of a particular style or color of an item, it may not be cost-effective to place a re-order if there are often minimum order quantities, or penalties when orders are below some threshold. Some items, in fact, may be orderable only in arrays that consist (as an example) of one gross of each color. When an item sells out in the two colors of a local university, for example, it may not be cost effective to order twelve gross, ten gross of which will languish along with the original shipment.

In many such cases, the deficiency remains unsatisfied because there is no method by which the order can be filled cost-effectively.

Further, re-order items may not be available at the factory or distributor level because they are back-ordered, closed out, or discontinued, resulting in lower profitability for the retailer whose inventory is comprised of partial size runs or limited color options, etc., making the product difficult to sell.

When all components of a distribution network are members of the same system, and all are interconnected by inventory management software, communications, and logistics mechanisms (shipping means), software can be devised to (1) recognize inequities, (2) react to trigger points, (3) make recommendations to management, (4) monitor the logistical implementation of solutions, and (5) create data structures that suggest improvements to ordering protocols that lessen the likelihood of repetitive problems. This is a prior art key business method by which organized distribution systems can be optimized to reduce obsolescence, minimize investment in inventory, improve overall profitability, protect branding, and maintain brand franchises.

At the other extreme, a retailer with a franchise to sell protected branded merchandise will load excess merchandise onto a truck at night and ship it to another outlet, unauthorized by the brand manager, and despite any obligation to not do such illicit dealings.

Between these two points exist many different potential solutions, of which none works well enough to satisfy the preponderance of the problems in the real world marketplace.

One problem with many existing inventory management systems is that they report to management when a given monitored item reaches a re-order level at a given location or storage point, but do not compare levels of different locations or storage points and report comparative levels.

Another problem with existing inventory management systems that monitor inventory levels at multiple sites is that they are not constructed to consider the value of the equalization of inventory between nodes (locations, or storage points, or distribution points).

Another problem is that many such systems do not provide a mechanism to recognize the cost of an overstock at one point, with aging and obsolescing inventory, with a simultaneous understock at a second point, with loss of sales due to nonavailability.

Another problem is that many such systems that do provide a mechanism that recognizes the importance of differential inventory levels, due to geographic preferences or errors made in placing orders, usually stop re-orders of obsolescing inventory and increase orders of understocked inventory, thus correcting the imbalance over time but in the least profitable manner.

Another fundamental problem with all such existing inventory management systems is that they apply exclusively to members of an integrated organization and not to transients or otherwise unaffiliated business units, and therefore the beneficiaries of such systems are only those who are part of that organization. For example, such a system that addresses the national distribution of product X might have the potential to do so for the organization that “owns and operates” the system, but not for the sole-site business that might benefit from its use, even if that sole-site's participation might assist the organization that operates the system by reducing its logistics costs.

While many of the prior art inventory management and equalization solutions may be suitable to one degree or another for the particular limited requirements they address, they are not optimum or generalized solutions for broad and diverse multi-node retail, wholesale, and distributor markets. Nor do they meet the needs of transients passing through the system to satisfy inventory imbalance requirements, and are not sufficiently flexible to be adaptable to the needs of many potential users.

### SUMMARY OF THE INVENTION

The present invention provides unique advantages and opportunities to retailers, assists wholesalers, distributors, manufacturers, and brand managers, and improves the cost-effectiveness and therefore the profitability of the business segments that adopt it.

In view of the foregoing disadvantages inherent in the prior art, the present invention diverges therefrom to provide systems and methods that satisfy the needs of multiple geographic nodes at the retail, wholesale, distribution, and even manufacturing levels.

The main objective of the present invention is to provide a cost-effective mechanism by which multiple distribution points, geographically diverse and each managing its own inventory, can efficiently interchange items that have accumulated at one point and become deficient at another through the use of peer-to-peer transactions, thereby benefiting all involved parties.

Another objective is to provide a channel of efficient communication by which at least two geographically diverse nodes of a distribution system, each managing its own inventory and with one suffering an understock of a given item while the other has an overstock condition of the same item, can negotiate the transfer of merchandise in one direction and funds or credits in the other.

Another objective is to provide a peer-to-peer communication system that a member's existing inventory management system can enter to report inventory status and initiate equalization transactions in an automated or semi-automated manner. Another objective is to provide an accounting system that collects, correlates, checks, and reports on all activities, facilitating record-keeping by participants.

Another objective is to provide an alternative means for conducting transactions through centralized brokers, namely using the peer-to-peer inventory management system for a subscription price, rather than a fee-per-use pricing scheme.

Another objective is to provide a software module that is compatible or can be made compatible with existing inventory management software products such that the software module is aware of inventory status.

Another objective is to provide a system that permits management to establish controls and local criteria for various actions, such that the software module is made aware of management input and decisions. The system must be adjustable depending on operating conditions and local market tastes of each participating node.

Another objective is to provide the software module with a hardware interface to the retailer's internet communication system and ISP.

Another objective is to provide the software module with an encryption capability that will ensure confidence and security as data is transmitted over the internet.

Another objective is to provide an encrypted authorization system that ensures that branded items, the distribution of which is controlled by the manufacturer or distributor, are not passed from an authorized node to a non-authorized node of the system.

Another objective is to provide a mechanism and system by which participating nodes can relieve inventory overstock and understock issues without the penalty of paying the respective charges and fees for such issues to distributors or manufacturers.

Another objective is to utilize the method for equalization of inventory in such a way as to protect brand integrity by reducing the likelihood of clandestine shipment of branded merchandise to off-price outlets, discount retailers and other like activities.

Another objective is to provide a mechanism and system that can be readily applied to other problems of supply and demand, such as in manufacturing where one manufacturer has an abundance of a little-used raw material and another has a deficiency thereof, and both benefit from equalization of their inventory via a cost-effective means for achieving a transaction.

It is the intention of the inventors that these objects apply equally to all situations involving a decentralized (hubless) peer-to-peer inventory management system applicable to any defined product category, characterized by (1) business entities with inventory surpluses, (2) automated or human entry of excess inventory and its characteristics in an internet message, (3) automated or human evaluation of “available” surpluses by the software modules at each node in the system, (4) automated or human comparison of “available” surpluses with local deficiencies, and (5) notification of management when a match is found by automated means, or automated closing of a transaction at the moment the system becomes aware a match has been found.

Other objects and advantages of the present invention will become known to the reader and it is intended that these objects and advantages be within the scope of the present invention.

To the accomplishment of the above and related objects, this invention may be embodied in the forms illustrated in the accompanying specification and drawings. However, the specification and drawings are illustrative only. There are many possible configurations and derivatives lying within the intended scope of the invention.

### BRIEF DESCRIPTION OF THE FIGURES

FIGS. 1-5 depict a preferred embodiment of the current invention showing the flow of information through the present invention, as it might be deployed in support of a random assembly of nodes (herein, by way of example, retail establishments).

Various other objects, features and attendant advantages of the present invention will become evident to one of ordinary skill in the art given this disclosure. However, these alternatives and derivatives are well within the spirit of the current invention.

FIG. 1 depicts the overall configuration of the inventory management system 100. Each of the at least two nodes 102 has an inventory management means 110 made up of an inventory database 104 and a comparison means 106. Each of the at least two nodes 102 interacts with the inventory database 104 via the communication means 103 which includes a data input means 103a and a data receipt means 103b. Comparison means 106 interacts with its respective node, the respective inventory database, and comparison means 106 to determine a complementary mis-stock inventory match. The comparison means sends a complementary match notification 203 to each of the at least two nodes involved in the complementary match.

FIG. 2 details a mis-stock inventory notification 107 which shows overstock and/or understock inventory of the at least to nodes from which the mis-stock notification 107 originated. The differing headers display varying descriptions of the inventory, including: The AUTHCODE, which is a category granting or denying access to desired inventory; the SKU, which is the Stock Keeping Unit or unique product identifier used to designate specific inventory; the SIZES-QTY, which are other terms used to designate the requested product data; the STORE ID-CONTACT, which allow human interaction to facilitate completion of the transaction; and the DATE-TIME, which sets the priority of messages, allowing for quick synchronization of relevant inventories.

FIG. 3 details the comparison means finding a complementary inventory match 201 of overstock and under stock inventory.

FIG. 4 is an example of a mis-stock inventory notification 107 with an authorization code. The list of overstocked inventories will be collected by the comparison means, there being a particular number at any given time. However, retrieval will depend on the correct AUTHCODE before the email is made visible to the requesting party. In this FIGURE, the email only allows access to AUTH 2 AND AUTH 7, denying access to the other overstock inventories not authorized.

FIG. 5 is an example of all complementary inventory matches 201 incorporated into a complementary match report 202. The comparison means 106 sends the complementary match report 202 in a complementary match notification 203 to each of the at least two nodes 102 involved in the complementary inventory match 201.

### DETAILED DESCRIPTION OF THE INVENTION

As used herein, the term “mis-stocked” is applied to overstocked inventory and understocked inventory. Also, variations of the word may be used, e.g., “mis-stock” and “mis-stocking”.

As used herein, the term “node” refers to a manufacturer, retailer, distributor, supplier, wholesaler or other business entity dealing with inventory and desiring to manage inventory using the current invention. The term “at least two nodes” refers to these same entities when using the invention system wherein there must be at least one overstocked entity and at least one understocked entity.

As used herein, the term “software module” refers to a software program combined with other modules to form a complete program. The software module interacts with the inventory database and performs inventory comparisons between the at least two nodes.

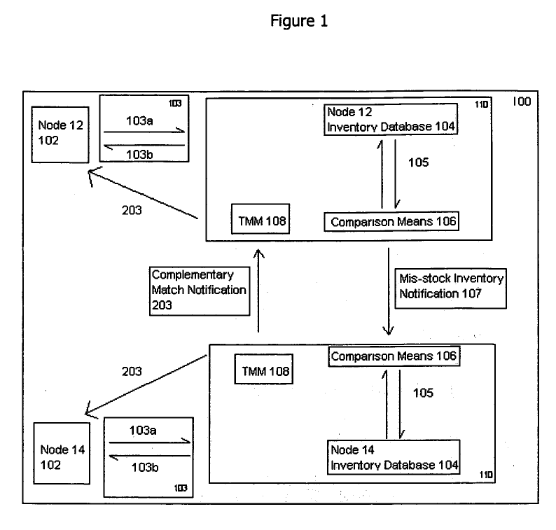

Turning to FIG. 1, wherein one embodiment of the current invention system and method is described. In the preferred embodiment, the peer-to-peer inventory management system (PTPIMS) 100 comprises at least two nodes 102, a communication means 103, and an inventory management means (IMM) 110.

The present invention provides for a network of nodes 12 and 14 which may be positioned at various locations. In a preferred embodiment, a practical system utilized by retailers is provided for the buying/selling of related products such as shoes. The nodes can be, for example, but not limited to, retailers, suppliers, manufacturers, distributors, wholesalers and other businesses involved in ultimately getting product to the consumer.

The concept of creating a network of nodes offers the potential of providing, heretofore, unavailable levels of service and efficiency. Agreements can be established between the owners of the nodes comprising the network. Through such agreements, it may be possible to provide merchandise to the nodes that are tailored to correspond to the individual needs of the nodes, such as overstocked and understocked inventory.

In FIG. 1, the communication means 103 comprises a means for transferring inventory information between nodes, 12 and 14, of the at least two nodes 102 and the IMM 110. In the preferred embodiment, the communication means 103 comprises both data input means 103a and data receipt means 103b. Furthermore, the communication means 103 can be any of a variety of means, including, but not limited to, a computer and a monitor, a telephone, a facsimile machine, a cellular phone, a palm pilot, electronic mail, online free data repositories, and combinations thereof. Still further, communication means 103 can be any of the aforementioned means utilizing the internet. Those of ordinary skill in the art will readily employ these and other communication means with the current invention.

The data input means 103a and the data receipt means 103b will function in a way that suits the communication means 103 employed. For example, if the communication means 103 is a computer, then the data input means 103a is any means of data input that is compatible with a computer, for example, a keyboard or a mouse. Similarly, the data receipt means 103b is any means of data input that is compatible with a computer, for example, a monitor or a printer. Those of ordinary skill in the art will readily employ these and other data input means and data receipt means with the current invention.

It is notable that the PTPIMS 100 can be configured to allow each node comprising the at least two nodes 102 of the system to have differing communication means 103. For example, node 14 can have a computer as the communication means 103, while node 12 can have a cellular phone or telephone as the communication means 103. The phone can both receive and send information. Functioning as a sending device, the phone can utilize analogue or digital technology in which the analogue configuration will utilize an analogue to digital conversion allowing the information to be digitally sent. Functioning as a receiving device, the phone can utilize analogue or digital technology in which the digital configuration will utilize a digital to analogue conversion allowing the received information to be heard. In the alternative, the digital configuration can be visually sent or received utilizing a visual display.

In an alternative example, the data that is input via a computer from node 14 can be received via a digital telephone by node 12. Such a configuration will utilize a digital to analog (voice) conversion allowing the information to be heard. Other data conversions include, but are not limited to, computer to paper (printer one direction, optical character recognition the other direction) and voice to computer (voice recognition software one direction, and voice over/voice readback software the other direction). Conversion of data from one to another communication means 103 is readily accomplished by those of ordinary skill in the art.

Data input to the PTPIMS 100 should describe the inventory. The description of the inventory should use common descriptors, thereby allowing the PTPIMS 100 to match described inventory from one node with described inventory from another node. This is inventory data that typically describes a node's inventory and whether that inventory is overstocked or understocked. In its most basic form, the input data can be a description of the inventory drafted similar to an advertisement or a technical specification sheet. A query using terms within the description will produce the description. This means of data input and data retrieval is similar to the technology employed by search engines for finding web pages. Also similar to web pages, this means is inefficient in that a variety of tangentially related inventory descriptions having query words will be produced and the user will have to manually review these documents for relevance. Similarly, by not using the proper search terms, inventory descriptions can be missed. Using common or predefined descriptors prevents mis-matches and missed results. For example, a search for the number of “boxes of shoes” will not produce an accurate result if shoe quantities are entered as “pairs of shoes.”

The IMM 110 of the PTPIMS 100 is preferably in silico, and most preferably comprises an inventory database 104, a comparison means 106 and a transaction management means (TMM) 108, FIG. 1. The inventory database 104 is a database of all inventory descriptions. In a preferred embodiment, the inventory database can include common descriptors, including, but not limited to, size, color, type, retail price, wholesale price, product description, model number, style number, inventory number, manufacture number, date and time, mis-stock quantity and digital images. A more preferable embodiment includes industry wide acceptable descriptors or terms easily identifiable by those in a specific industry.

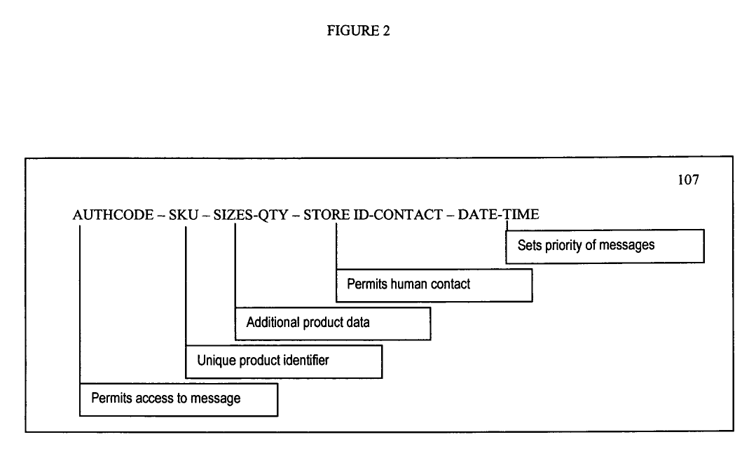

In the most preferred embodiment, the inventory database can include a stock keeping unit (SKU) or a unique product identifier. The SKU standardizes the description of inventory so that the software module can quickly and efficiently query inventory in the system. In FIG. 2, the SKU information is stored in the inventory database and the SKU numbers and any other provided information are compared. SKUs are often times a series of numbers linked to specific information including, but is not limited to, size, color, type, retail price, wholesale price, product description, model number, style number, inventory number, manufacture number, mis-stock quantity, digital images, date and time or any other relevant detail as determined by the retailer and the inventory product.

In a preferred embodiment, the comparison means 106 comprises a software module wherein the software module is an interface between the inventory database 104 and an at least two nodes 102. The software module can be incorporated into the inventory management means 110 or can be purchased by the at least two nodes to be installed onto the inventory management means 110. The present invention provides for a network of software modules. The software module determines overstock and understock inventory from each of the at least two nodes 102 and then compares the corresponding inventory levels to determine a complementary inventory match between the at least two nodes 102.

The software module can, for example, determine inventory levels for a network of at least two nodes 102. For example, each software module can determine the inventory levels from the inventory database of node 12 and 14 by retrieving inventory SKU data from the inventory database of node 12 and 14, and determine complementary inventory matches between these two nodes. The inventory levels can be, for example, but not limited to, overstock inventory, understock inventory, adequate inventory, and projected inventory. The software module can determine inventory levels by, for example, utilizing a projection analysis of past and present inventory trends, a color coded analysis wherein specified colors represent inventory levels, and a comparison analysis wherein a predetermined threshold is compared to the current inventory value.

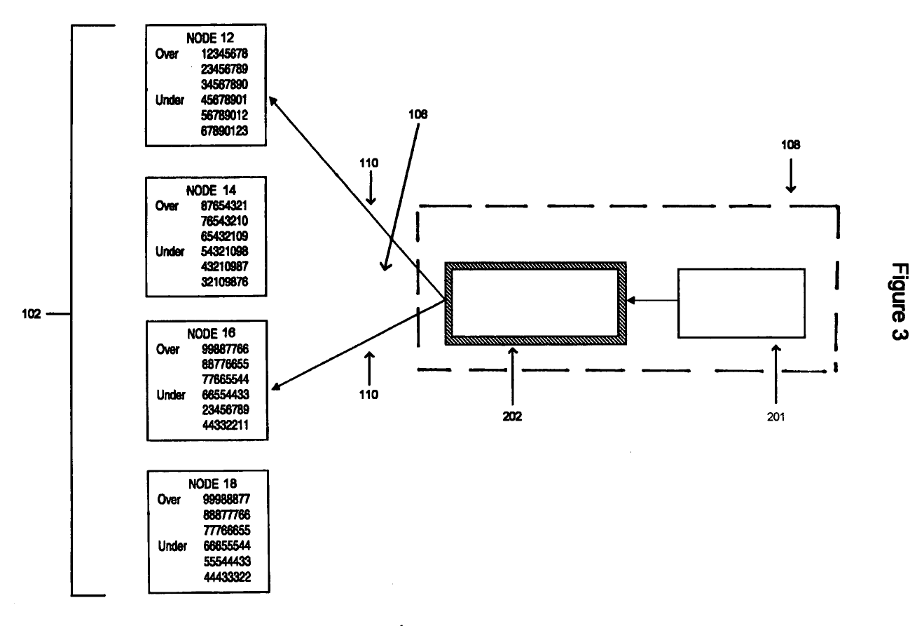

The software module can determine the inventory of another at least two nodes 102 by utilizing, for example, an internet communication system and a message format whereby the message format produces a notification of inventory status and the software module receives this notification and compares it to existing inventory levels to determine a complementary inventory match 201, FIG. 3.

In an alternate embodiment, the software module can determine the inventory of another at least two nodes 102 by utilizing, for example, data-mining techniques, whereby the software module sends a database program to an at least two nodes to search for mis-stock inventory or patterns of mis-stock inventory in the inventory database 102 that can be used to predict future inventory levels. This information is then relayed back to the software module and compared with the inventory database to evaluate a potential complimentary inventory match 201.

In a preferred embodiment, the software module of node 12 communicates with the node 12 inventory database 104 to recognize a mis-stocked inventory. It then produces and sends a mis-stock notification 107 to the software module of node 14. FIG. 2 shows possible information included in the mis-stock inventory notification 107. This includes, but is not limited to, an authorization code permitting access to the message, SKUs, additional product data including but not limited to size, quantity, color, store ID and contact, and date and time. The software module of node 14 compares the mis-stock inventory notification 107 with the node 14 inventory database 104 to determine a complementary inventory match 201.

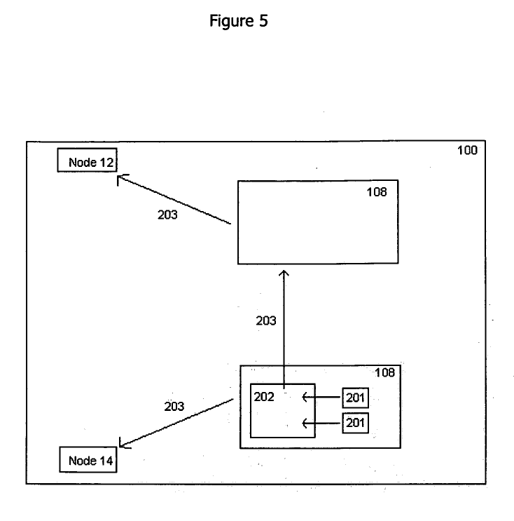

Once a complementary inventory match 201 has been determined, the TMM 108 notifies the at least two nodes 102 of the complementary inventory match 201, orchestrates payment, and establishes inventory shipping instructions by and between nodes determined to have a complementary inventory match 201. In a preferred embodiment, the TMM 108 comprises of a software module wherein the software module communicates with the software modules from the at least two nodes 102, FIG. 1. The software module of node 14 incorporates all complementary inventory matches 201 into a complementary match report 202 and sends a complementary match notification 203 to the software module of node 12 which in turn sends a complementary match notification 203 to node 12 and awaits instruction, FIG. 5. In addition, software module of node 14 sends node 14 a complementary match notification 203. The complementary match notification 203 includes a variety of means, including, but not limited to a computer and a monitor, a telephone, a facsimile machine, a cellular phone, a palm pilot, electronic mail, online free data repositories, and combinations thereof.

Once the at least two nodes receives a complementary match notification 203, the process of confirmation, shipping and payment can occur. The confirmation, shipping and payment can occur by the software module, via e-mail correspondence between the two nodes, or via a transient webpage wherein the two nodes complete the transaction by communicating on a secured webpage. If the software module of node 12 is authorized to undergo the inventory transaction, the software module of node 12 sends a confirmation to the software module of node 14. Payment method varies with each node and can be, for example, but is not limited to, a hold instruction pending further instructions by the node, a hold instruction pending confirmation by a node, a commit instruction pending payment by the node, and a commit and pay instruction. A payment and shipping notification 300 is then sent from the software module of node 14 to the software module of node 12 with the preferred payment method and shipping instructions which are then carried out by the respective nodes.

IMM 110 further may comprise a complementary match ranking function for communicating the most relevant complementary match to one node of the at least two nodes 102. This is useful when there is more than one match of complementary inventory.

An additional feature of the communication means 103 is the management of authorized users. This optional step is referred to as the authentication process and is useful for managing the nodes when the inventory is designated as that which can only be sold by approved retailers. Many manufacturers, particularly high quality brand name manufacturers, prefer that their merchandise is not sold by certain types of retailers. Typically, such retailers are discount retailers and such manufacturers are manufactures of high end or exclusive merchandise. To prevent such trafficking in goods using the current invention PTPIMS 100, IMM 110 can require a node to present authorization before a complementary match of certain inventory is produced. In this situation, the software module of node 12 communicates with the node 12 inventory database 104 to recognize mis-stocked inventory.

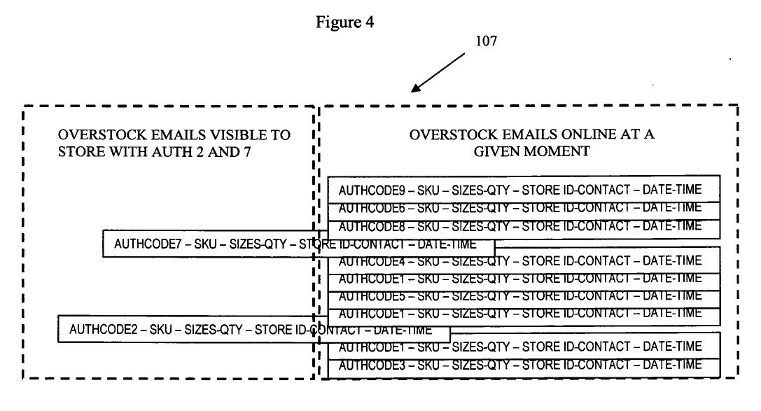

The software module of node 12 produces and sends a mis-stocked inventory notification 107 to the software module of node 14. Before the mis-stock inventory is communicated to node 14, node 14 must qualify as an authorized retailer of this inventory. Authorization can include, but is not limited to, authorization codes and passwords and periodic emails that are either manually or automatically entered into the database of the software module, FIG. 4. These are just two examples of authorization and others are readily apparent to those of ordinary skill in the art. Once authorization is obtained, the software module of node 14 compares the mis-stock notification 107 with the node 14 inventory database 104 and continues the inventory transaction.

It is preferred, but not necessary, that the identities of the at least two nodes 102 using PTPIMS 100 are kept private by PTPIMS 100 until after the transaction is secured. Privacy achieves many objectives, including preventing nodes from using the system to scan for inventory and then arranging transactions directly. Such direct transactions results in loss of profit for the manager of the PTPIMS 100 system. This is because the manager of the PTPIMS 100 system will likely receive a payment for administrating the transaction. In an alternate embodiment, it is possible for the identifies of the at least two nodes 102 to be public. In this type of a situation, for example, the at least two nodes 102 may pay a membership fee to browse, and list inventory on PTPIMS 100. Further still, this public identity situation may apply when the manager of the PTPIMS 100 is part of a single business entity managing inventory within satellite business units, which comprise the at least two nodes 102. Varieties of other possibilities exist and will become known to the ordinary practitioner in the art.

Those ordinarily skilled in the art will immediately recognize the versatility of the current invention and will apply the invention inventory management system to a variety of different inventory items. The inventory items may vary from the shoes of the current example without departing form this disclosed invention. Similarly, the methods for practicing this invention and the means for accomplishing these method steps are versatile. Steps may present in different order, or may be omitted. Additional steps may be added to the method steps presented. These variations are well within the spirit of the current invention.

### EXAMPLES

The invention is further described by these following examples. In the examples, the node is a retailer, though it could be any entity that deals with inventory, from the manufacturer to the distributor. Also, for simplicity, the invention is described using a shoe retail and electronic part manufacturer and the IMM 110 is likewise in silico. Variations to these examples are well within the skills of those ordinarily skilled in the art. These variations are well within the spirit of this current invention.

There are many possible product lines and categories to which the invention properly applies, and each has its own characteristics and jargon that distinguish it from others. To facilitate understanding only, but not to exclude other applications, the invention will be discussed as it applies to the retail shoe and electronic parts business. Thus, the at least two nodes 102 are retailers in the shoe industry and manufactures of electronic parts.

It is also preferred in these examples that all inventories managed by the IMM 110 are identified as to model number, style number, size, type, style, retail price, etc. using a SKU. As discussed above, the SKU allows the at least two nodes to readily conduct transactions in accordance with common descriptors.

This example does not exclude the potential of using other communication and information management mechanisms.

### Example 1

Node 12 has a surplus of 24 pairs of shoes identified as SKU #23456789 (distribution of which is protected/defended by the manufacturer), which retail at $100 and wholesale at $40. Node 14 has a corresponding deficiency, but neither node knows of the other and they are located in different countries, FIG. 1. In this example, the identities of the at least two nodes 102 are kept private so that the PTPIMS 100 manager can realize a business objective by charging a transaction fee.

Here, each software module includes a unique authorization code for product in the inventory database, FIG. 4. A vendor qualifies the node for certain inventory transactions by a sales representative upon periodic visits. The software module of node 12 has been authorized for inventory transactions of shoes with SKU #23456789 whereby the SKU is a series of numbers with information including size, color, type, retail price, wholesale price, product description, model number, style number, inventory number, manufacture number, mis-stock quantity, date and time and digital images. These SKU numbers are attached to a specification of the shoes, and so, the shoes are presented to the inventory database.

Here the communication means 103 for node 12 and node 14 allowing each of the at least two nodes 102 to update their corresponding inventory database is a computer. Since the communication means 103 is a computer, the data input means of node 12 and node 14 is any means of data input that is compatible with a computer, for example a keypad. Similarly, the data receipt means is any means of data receipt that is compatible with a computer, for example a monitor. Node 12 and node 14 input the surplus of 24 pairs of shoes for SKU #23456789 using a keypad.

The comparison means 106 comprises, in this example, two software modules, one specific for node 12 and node 14. Each software module communicates with the corresponding inventory database to determine overstock and understock values using inter-software communication 105, FIG. 1.

Once an overstock value is determined, the software module of node 12 communicates with the software module of node 14 to recognize mis-stocked inventory. In this example, mis-stock inventory is described using a simple SKU number. The software module of node 12 produces and sends a mis-stocked inventory notification 107 to the software module of node 14 listing overstock SKU numbers: 12345678, 23456789, and 34567890, and listing understock SKU nos.: 45678901, 56789012, and 67890123. The software module of node 14 compares the information contained in the mis-stock inventory notification 107 with the node 14 inventory database 104 which lists overstock SKU numbers 99887766, 88776655, and 77665544 and understock SKU numbers 66554433, 23456789, and 44332211, FIG. 3. This step is labeled comparison step 200. The software module of node 14 finds the tentative match between overstock SKU number 23456789 of node 12 inventory database 104 and understock SKU number 23456789 of node 14 inventory database 104 thereby creating complementary inventory match 201.

There are many possible types of information and combinations thereof which could be included in the mis-stock inventory notification 107. To facilitate understanding only, but not to exclude other types of information, FIG. 2 shows possible information included in the mis-stock inventory notification 107. This includes, but is not limited to, authorization code permitting access to the message, SKUs, additional product data including but not limited to size, quantity, color etc., store ID and contact, and date and time.

Once the comparison means 106 determines a complementary inventory match 201, the TMM 108, utilizing the software module of node 14, incorporates all complementary inventory matches 201 into a complementary match report 202 and then notifies the software module of node 12 of the complementary match by sending a complementary match notification 203 to the software module of node 12. FIG. 5 illustrates a complementary match notification 203 sent to the software modules of nodes 12 and 14.

A complementary match notification 203 comprises a group of complementary inventory matches 201 based on one or more of a variety of factors, including, first to match, best fit, date since SKU upload and others. Those ordinarily skilled in the art will employ these factors for generating complementary match notifications that best suit any particular set of nodes, inventory and desired goals using this current invention. Use of these various factors is well within the spirit of the current invention. Here the complementary match notification 203 is a first to match and is communicated to node 12 and node 14 via an e-mail.

Once a complementary match notification 203 has been sent, the TMM 108 can complete the transaction in a variety of ways. Here, node 14 having the understock value has established transaction criteria for node 12 to meet. Once the transaction criteria are met, the software module of node 12 communicates an authorization and acceptance notification 205 to the software module of node 14 to complete the transaction. The software module of node 14 then sends a payment and shipping notification 300 to the software nodule of node 12 which are carried out by the respective node. Should node 14 decide to reject the overstock inventory of node 12, node 12 is not notified of the solicitation, and the software module will communicate a complementary match notification 203 to the next best fitting node.

At the end of the transaction, node 12 has fewer SKU #23456789 shoes which were not selling in the specific demographic market of node 12 and has money available with which to order merchandise with a higher likelihood of selling. Node 14 has more SKU #23456789 shoes which sell in the specific demographic market of node 14. Preferably, the PTPIMS 100 manager has earned a fee for facilitating the transfer.

### Example 2

Node 12 has a surplus of 24 pairs of shoes identified as SKU #23456789 (distribution of which is protected/defended by the manufacturer), which retail at $100 and wholesale at $40. Node 14 has a corresponding deficiency, but neither node knows of the other and they are 1000 miles apart. In this example, the identities of the at least two nodes 102 are kept private so that the PTPIMS 100 manager can realize a business objective by charging a transaction fee.

In this example, each software module includes a unique code authorization for product in the inventory database, FIG. 4. Here, a vendor qualifies the node for certain inventory transactions by a sales representative upon periodic visits. The software module of node 12 has been authorized for inventory transactions of shoes with SKU #23456789 whereby the SKU is a series of numbers with information including size, color, type, retail price, wholesale price, product description, model number, style number, inventory number, manufacture number, mis-stock quantity, date and time and digital images. These SKU numbers are attached to a specification of the shoes, and so, the shoes are presented to the inventory database.

Here the communication means 103 for node 12 and node 14 allowing each of the at least two nodes 102 to update their corresponding inventory database is a cellular phone and a personal digital assistant (PDA), respectively. Since the communication means 103 is a cellular phone and a PDA, the data input means of node 12 is any means of data input that is compatible with a cellular phone, for example a keypad, and the data input means for node 14 is any means of data input that is compatible with a PDA, for example a touch screen. Similarly, the data receipt means is any means of data receipt that is compatible with a cellular phone or a PDA, for example, a computer. Node 12 inputs the surplus of 24 pairs of shoes for SKU #23456789 using a cellular phone and node 14 inputs the corresponding deficiency using a PDA.

The comparison means 106 comprises in this example two software modules, one specific for both node 12 and node 14. Each software module communicates with the corresponding inventory database to determine overstock and understock values using inter-software communication 105.

Once an overstock value is determined, the software module of node 12 communicates with the software module of node 14 to recognize mis-stocked inventory. In this example, mis-stock inventory is described using a simple SKU number. The software module of node 12 produces and sends a mis-stocked inventory notification 107 to the software module of node 14 listing overstock SKU numbers: 12345678, 23456789, and 34567890, and listing understock SKU nos.: 45678901, 56789012, and 67890123. The software module of node 14 compares the information contained in the mis-stock inventory notification 107 with the node 14 inventory database 104 which lists overstock SKU numbers 99887766, 88776655, and 77665544 and understock SKU numbers 66554433, 23456789, and 44332211. This step is labeled comparison step 200. The software module of node 14 finds the tentative match between overstock SKU number 23456789 of node 12 inventory database 104 and understock SKU number 23456789 of node 14 inventory database 104 thereby creating complementary inventory match 201.

There are many possible types of information and combinations thereof which could be included in the mis-stock inventory notification 107. To facilitate understanding only, but not to exclude other types of information, FIG. 2 shows possible information included in the mis-stock inventory notification 107. This includes, but is not limited to, authorization code permitting access to the message, SKUs, additional product data including but not limited to size, quantity, color etc., store ID and contact, and date and time.

Once the comparison means 106 determines a complementary inventory match 201, the TMM 108, utilizing the software module of node 14, incorporates all complementary inventory matches 201 into a complementary match report 202 and then notifies the software module of node 12 of the complementary inventory match 201 by sending a complementary match notification 203 to the software module of node 12. FIG. 5 illustrates a complementary match notification 203 sent to the software modules of nodes 12 and 14.

A complementary match notification 203 comprises a group of complementary inventory matches 201 based on one or more of a variety of factors, including, first to match, best fit, date since SKU upload and others. Those ordinarily skilled in the art will employ these factors for generating complementary match notifications 203 that best suit any particular set of nodes, inventory and desired goals using this current invention. Use of these various factors is well within the spirit of the current invention. Here the complementary match notification 203 is a first to match and is communicated to node 12 and node 14 via an e-mail.

The TMM 108 can complete the transaction in a variety of ways. Here the software module holds the payment received from node 14 for the overstock inventory of node 12 until node 14 reports, via communication means 106, that the overstock merchandise has been received. In this embodiment, the software module of node 14 has notified node 12 that node 14 is interested in acquiring the overstock for SKU #23456789. The software module of node 14 also notifies node 12 that node 14 has submitted payment for the overstock inventory by communicating to node 12 a payment notice 301. In a preferred embodiment, the software module of node 12 ensures that the payment from node 14 clears (e.g., sufficient finds). Node 12 will then ship the overstock inventory to node 14 using common shipping means.

At the end of the transaction, node 12 has fewer SKU #23456789 shoes which were not selling in the specific demographic market of node 12 and has money available with which to order merchandise with a higher likelihood of selling. Node 14 has more SKU #23456789 shoes which sell in the specific demographic market of node 14. Preferably, the PTPIMS 100 manager has earned a fee for facilitating the transfer.

### Example 3

Node 12 has a surplus of 100 electronic parts identified as SKU #23456789 (distribution of which is protected/defended by the manufacturer), which retail at $200 and wholesale at $50. Node 14 has a corresponding deficiency of 50 electronic parts and node 16 has a corresponding deficiency of 150 electronic parts. Neither node knows of each other and they are located on different continents. In this example, the identities of the at least two nodes 102 are made public as the nodes pay a membership fee to browse and list inventory on PTPIMS 100.

In this example, each software module includes a unique code authorization for product in the inventory database, FIG. 4. Here, a vendor qualifies the node for certain inventory transactions via periodic encrypted e-mails that are either manually or automatically entered into the database of the software module.

Here, the software module of node 12 has been authorized for inventory transactions of shoes with SKU #23456789 whereby the SKU is a series of numbers with information including type, retail price, wholesale price, product description, model number, style number, inventory number, manufacture number, date and time, mis-stock quantity, and digital images. These SKU numbers are attached to a specification of the electronic parts, and so, the electronic parts are presented to the inventory database.

Here, the communication means 103 for node 12, node 14 and node 16, thereby facilitating each of the at least two nodes 102 to input their inventory values into the inventory database 104, is a computer. The data input means of all three at least two nodes 102 is any means of data input that is compatible with a computer, for example, a keyboard. Similarly, the data receipt means of all three at least two nodes 102 is any means of data receipt that is compatible with a computer, for example, a monitor. All three of the at least two nodes 102 input their mis-stocked electronic part quantities of SKU #23456789 using a keyboard.

The comparison means 106 comprises, in this example, three software modules, one specific for node 12, node 14 and node 16. Each software module communicates with the corresponding inventory database to determine overstock and understock values using inter-software communication 105.

Once an overstock value is determined, the software module of node 12 communicates with the software module of node 14 and node 16 to recognize mis-stocked inventory. In this example, mis-stock inventory is described using a simple SKU number. The software module of node 12 produces and sends a mis-stocked inventory notification 107 to the software module of node 14 and node 16 listing overstock SKU numbers: 12345678, 23456789, and 34567890, and listing understock SKU nos.: 45678901, 56789012, and 67890123. The software module of node 14 compares the information contained in the mis-stock notification 107 with the node 14 inventory database 104 which lists overstock SKU numbers 99887766, 88776655, and 77665544 and understock SKU numbers 66554433, 23456789, and 44332211. In addition, the software module of node 16 compares the information contained in the mis-stock inventory notification 107 with the node 16 inventory database 104 which lists overstock SKU numbers 11223344, 22334455, and 33445566 and understock SKU numbers 44556677, 23456789, and 66778899. This step is labeled comparison step 200. The software module of node 14 finds the tentative match between overstock SKU number 23456789 of node 12 inventory database 104 and understock SKU number 23456789 of node 14 inventory database 104 thereby creating complementary inventory match 201. The software module of node 16 finds the tentative match between overstock SKU number 23456789 of node 12 inventory database 104 and understock SKU number 23456789 of node 16 inventory database 104 thereby creating complementary inventory match 201.

Example 2 illustrates a simple complementary inventory match 201; however, given the volume of inventory that will be provided by numerous nodes using the invention system, complementary matching can be more difficult. For example, here a first node has an overstock of 100 units of inventory and both a second node and a third node have an understock of this same inventory; second node being understocked by 50 units and third node being understocked by 150 units. All three nodes are using the current invention system. It is more efficient for the first node to send the 100 units of overstock inventory to a single location, thereby reducing costs of shipping and preparing for shipping and etc. So, in this scenario, the PTPIMS 100 takes into account that the better complimentary match is the first node with the third node, than the first node with the second node, remainder to the third node. This and other such efficiencies comprise part of the PTPIMS 100 in an alternative embodiment.

Here, the TMM 108 facilitates payment and shipment of the inventory between the at least two nodes 102 via the software modules. Node 14 has an understock value and an established transaction criteria for node 12 to meet. Once the transaction criteria are met, the software module of node 12 communicates an authorization and acceptance notification 205 to the software module of node 14 to complete the transaction. Node 12 has an overstock and node 14 has an understock, and node 14 has accepted the overstock inventory from node 12. In this embodiment, node 14 can accept the node 12 overstock by submitting payment 300. The payment submission 300 is preferably by credit card, but can be any payment method, including, but not limited to wire transfer, check, credit card, charge against PayPal or similar, charge against BMP account, etc. The payment submission 300 is transmitted to node 12 using the software module which includes shipping instructions. Node 12 then carries out the shipping instructions from node 14. Identities of nodes 12 and 14 are revealed to each other during the payment/shipment process.

At the end of the transaction, node 12 has fewer SKU #23456789 shoes which were not selling in the specific demographic market of node 12 and has money available with which to order merchandise with a higher likelihood of selling. Node 14 has more SKU #23456789 shoes which sell in the specific demographic market of node 14. Preferably, the PTPIMS 100 manager has earned a fee for facilitating the transfer.

The present invention allows users to search for differences in other users' records and mediate an interaction such that those users with an understock inventory will find those with an overstock inventory and vice versa. The objective of the present invention is to equalize inventories of varying users and to transfer desired quantities to geographically distinct regions, such that the transfer will yield a benefit for both users.

I claim:

1. An in silico enabled peer-to-peer inventory management system, comprising:
(a) at least two nodes;
(b) a communication means; and
(c) an inventory management means; further comprising,
(i) an inventory database;
(ii) a comparison means; and
(iii) a transaction management means,
wherein the inventory management means communicates inventory data to the nodes using the communication means, the communicated inventory data is compared by the comparison means, compatible matches are communicated back to the nodes by the transaction management means and an inventory exchange of the compatible matches are carried out by the transaction management means.

2. The system of claim 1 wherein the at least two nodes are businesses dealing with inventory and having mis-stock of a particular inventory.

3. The system of claim 2 wherein the at least two nodes comprises retailers, suppliers, manufacturers, distributors, wholesaler or other business entities.

4. The system of claim 3 wherein the at least two nodes comprises retailers.

5. The system of claim 1 wherein the communication means is a means comprising a computer and monitor, a telephone, a facsimile machine, a cellular phone, a personal digital assistant (PDA), electronic mail, online free data repositories and combinations thereof.

6. The system of claim 5 wherein the communication means utilizes the internet.

7. The system of claim 1 wherein the communication means further comprises a data input means and data receipt means.

8. The system of claim 7 wherein the data input means comprises a computer keyboard, a palm keypad, a microphone, a scanner, a telephone keypad, a cellular phone keypad and combinations thereof.

9. The system of claim 7 wherein the data receipt means comprises a computer and monitor, a speaker, a printer, a cellular phone, a PDA, a facsimile machine and combinations thereof.

10. The system of claim 1 wherein the at least two nodes communicates inventory data to the inventory management means.

11. The system of claim 10 wherein the inventory data communicated to the inventory management means is a stock keeping unit.

12. The system of claim 1 wherein the inventory management means further comprises of a means to provide inventory data, an input/output means and reporting protocol that is suitable to the present invention.

13. The system of claim 1 wherein the inventory database comprises, but not limited to, unique product identifiers, stock keeping units, pictures, retail prices, wholesale prices, product description, and other inventory identifiers.

14. The system of claim 1 wherein the comparison means further comprises a means to determine inventory levels of one node, a means to determine inventory levels of another node, and a means to determine a complementary match of inventory levels between the at least two nodes.

15. The system of claim 14 wherein inventory levels include, but are not limited to, overstock inventory, understock inventory, adequate inventory, and projected inventory.

16. The system of claim 14 wherein the means to determine inventory levels of one node includes, but is not limited to, a projection analysis of past and present inventory trends, a color coded analysis wherein specified colors represent inventory levels, a comparison analysis wherein a predetermined threshold value is compared to the current inventory value.

17. The system of claim 14 wherein the means to determine inventory levels of another node include data-mining.

18. The system of claim 17 wherein data-mining comprises an internet communication system.

19. The system of claim 14 wherein the means to determine inventory levels of another node includes an internet communication system and a message format.

20. The system of claim 19 wherein the message format provides information regarding inventory status between the nodes of at least two nodes including overstock and understock inventory.

21. The system of claim 19 wherein the message format comprises electronic mail, automated messages, faxed messages or the like.

22. The system of claim 14 wherein the means to notify the at least two nodes of an established complementary inventory match comprises of a message format.

23. The system of claim 22 where in the message format provides information regarding inventory status between the nodes of at least two nodes including overstock and understock inventory.

24. The system of claim 1 wherein the comparison means comprises a software module.

25. The system of claim 14 wherein the comparison means further comprises a means authorizing a node to view a message regarding inventory levels of another node.

26. The system of claim 25 wherein the authorization means is determined by a node wherein the comparison means is either manually authorized or automatically authorized via encrypted emails.

27. The system of claim 1 wherein the inventory management means further comprises a transaction management means to notify the at least two nodes of an established complementary inventory match, to orchestrate payment for the inventory, and to establish inventory shipping instructions by and between nodes determined to have a complementary inventory match.

28. The system of claim 27 wherein the transaction management means comprises an automatic payment means.

29. The system of claim 28 wherein the transaction management means comprises a means to complete the exchange of a complementary inventory match pending further instructions by the node including, but not limited to, a hold instruction pending confirmation by a node, a hold instruction pending authorization by a node, a commit instruction pending payment by the node, and a commit and pay instruction.
